(19) United States
(12) Patent Application Publication
(10) Pub. No.: US 2016/0309435 A1
(43) Pub. Date: Oct. 20, 2016

(54) SEGMENT SYNCHRONIZATION METHOD FOR NETWORK BASED DISPLAY

(71) Applicant: Korea Electronics Technology Institute, Seongnam-si (KR)

(72) Inventors: Byoung Chul SONG, Seoul (KR); Jung Wook WEE, Seoul (KR); Kyung Taek LEE, Seongnam-si (KR); Kyung Won PARK, Seoul (KR)

(73) Assignee: Korea Electronics Technology Institute, Seongnam-si (KR)

(21) Appl. No.: 14/952,021

(22) Filed: Nov. 25, 2015

(30) Foreign Application Priority Data
Apr. 14, 2015 (KR) 10-2015-0052332

(51) Int. Cl. H04W 56/00

(52) U.S. Cl. CPC H04W 56/0015; H04W 84/20

(57) ABSTRACT

A segment synchronization method of a network-based display is provided. The network segment synchronization method forms a plurality of network segments, selects a single terminal in the network segment as a segment master, sets the other terminals in the network segment as segment slaves, and synchronizes, by the segment slaves, time to the segment master of the network segment to which the segment slaves belong. Accordingly, a function of synchronizing can be provided to super multi-view network terminals without a bridge (switch) providing an existing gPTP function for each port.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Apr. 14, 2015, and assigned Serial No. 10-2015-0052332, the entire disclosure of which is hereby incorporated by reference.

### TECHNICAL FIELD OF THE INVENTION

The present invention relates generally to synchronizing for a display, and more particularly, to synchronizing time of projectors which are connected to an Ethernet network in a super multi-view display terminal system using the projectors.

### BACKGROUND OF THE INVENTION

FIG. 1 is a view showing a large super multi-view terminal system. To implement a projector-based super multi-view display, time synchronization should be performed between image reproducing terminals connected to projectors. To achieve time synchronization between terminals, the terminals are connected with one another through an Ethernet network, and time synchronization may be performed using a generalized Precision Time Protocol (gPTP) of the IEEE 802.1AS standard.

To synchronize time, a clock frequency and a propagation delay of all devices should be measured. In addition, the gPTP synchronizes frequencies of all terminals to a Grand Master (GM) existing on a local network or a GM terminal determined through a Best Master Clock selection Algorithm (BMCA).

To achieve this, the IEEE 802.1AS standard provides a mechanism for transmitting and receiving and synchronizing a PTP message on Layer 2. The process of synchronizing GM clock frequency of devices is as follows. A frequency rate between two neighboring systems is calculated by exchanging a PTP message, and a rate between the GM frequency and the local clock frequency of the prior system is updated using the frequency rate. All of the terminals connected to a local network are synchronized for the GM clock through the above-described synchronization process.

In the case of Full-Duplex (FD) IEEE 802.3 link, a peer-delay mechanism is used to measure a propagation delay. FIG. 2 is a view to illustrate a method for measuring a propagation delay using a peer-delay mechanism.

Normal propagation delay measurement starts by transmitting a Pdelay_Req message at time t1. When the Pdelay_Req message is received, time t2 when the Pdelay_Req message is received is recorded on a Pdelay_Resp message, and the Pdelay_Resp message is transmitted, and time t3 when the Pdelay_Resp is transmitted is recorded on a Pdelay_Resp_Follow_Up message and the Pdelay_Resp_Follow_Up message is transmitted. The device which transmits the Pdelay_Req message may secure reciprocating time t4-t1 at time t4 when the Pdelay_Resp_Follow_Up is received, and the device which receives the Pdelay_Req message may secure time t3-t2 taken to respond with the Pdelay_Resp message through a response message. Therefore, uni-directional average propagation delay time D is calculated using times t1, t2, t3, and t4. However, since there is a difference in the local oscillator frequency between the two systems measuring times t1 and t4 and times t2 and t3, times t2 and t3 should be adjusted.

The Pdelay_Req message may be used to determine whether a device connected to each port provides a function of configuring a gPTP (that is, whether IEEE 802.1AS is supported or not) in addition to the purpose of measuring the propagation delay. When the Pdelay_Req message is transmitted, the device connected to the end of the port is determined not to support the IEEE 802.1AS in the following cases:
a) where a response message is not received;
b) where two or more response messages are received; or
c) where a measured propagation delay exceeds a specific threshold value.

As described above, the gPTP performs time synchronization for the entire network through time synchronization between neighboring devices. As shown in FIG. 3, the GM device has all ports serving as masters, and another device connected to each of the ports serves as a slave and synchronizes time to the GM. Through the above-described process, the GM performs time synchronization with the devices connected to the end.

To establish such a network, terminal devices should be connected to a network switch, and the network switch should be provided with the above-described function to use the gPTP. However, switches supporting the gPTP are being sold high, and thus a cost saving effect could be predicted if the gPTP is implemented by using a normal switch.

### SUMMARY OF THE INVENTION

To address the above-discussed deficiencies of the prior art, it is a primary aspect of the present invention to provide a method for setting and synchronizing clock between system terminals even in a switch, a bridge, or a switching hub which does not have the existing IEEE802.1AS function by applying a new method to the IEEE802.AS and embodying in a super multi-view system. This method can be used in a service program which provides a screen by setting and synchronizing exact time between a plurality of display devices (tens to hundreds of devices).

According to one aspect of the present invention, a network segment synchronization method includes: forming a plurality of network segments; selecting a single terminal in the network segment as a segment master; setting the other terminals in the network segment as segment slaves; and synchronizing, by the segment slaves, time to the segment master of the network segment to which the segment slaves belong.

The network segment synchronization method may further include synchronizing, by the segment masters, time to a grand master.

The synchronizing the time to the segment master may include synchronizing time by exchanging a gPTP packet using a uni-cast address of the segment master, and the synchronizing the time to the grand master may include synchronizing time by exchanging a gPTP packet using a unit-cast address of the grand master.

The grand master may not belong to the network segments.

The terminals constituting a single network segment may be connected to a single switching hub.

According to another aspect of the present invention, a network system includes: a plurality of network segments; and a grand master. A single terminal may be selected as a segment master in a single network segment, and the other terminals are set as segment slaves, the segment slaves may synchronize time to the segment master of the network segment to which the segment slaves belong, and the segment master may synchronize time to the grand master.

According to exemplary embodiments of the present invention described above, a function of synchronizing can be provided to super multi-view network terminals without a bridge (switch) providing an existing gPTP function for each port.

In addition, according to exemplary embodiments of the present invention, a synchronizing function can be provided using an existing switching hub, switching bridge, switch, etc. in a network where super multi-view network terminals are connected.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view showing a large super multi-view terminal system;

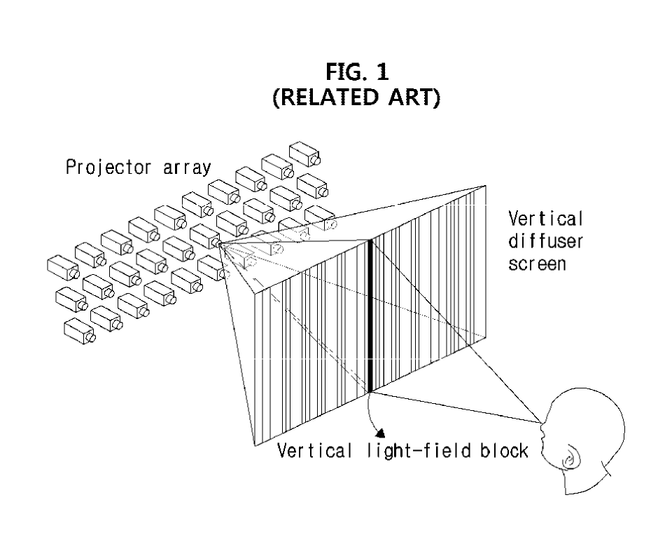

FIG. 2 is a view to illustrate a method for measuring a propagation delay using a peer-delay mechanism;

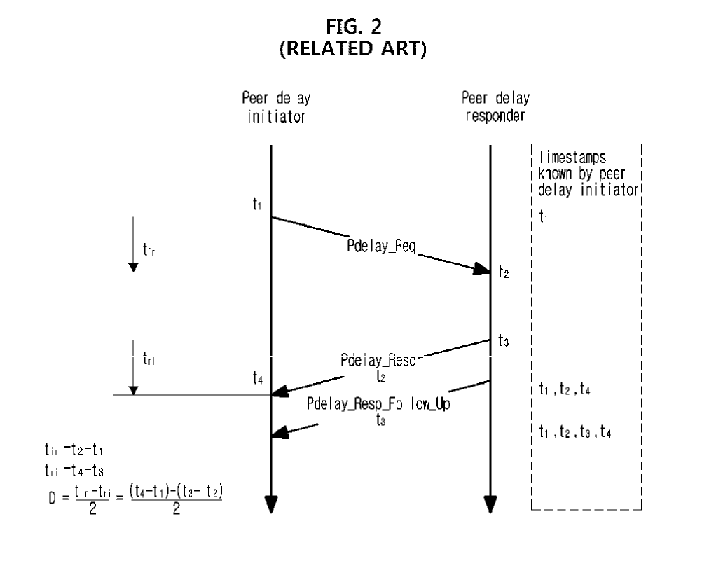

FIG. 3 is a view showing an example of gPTP connection;

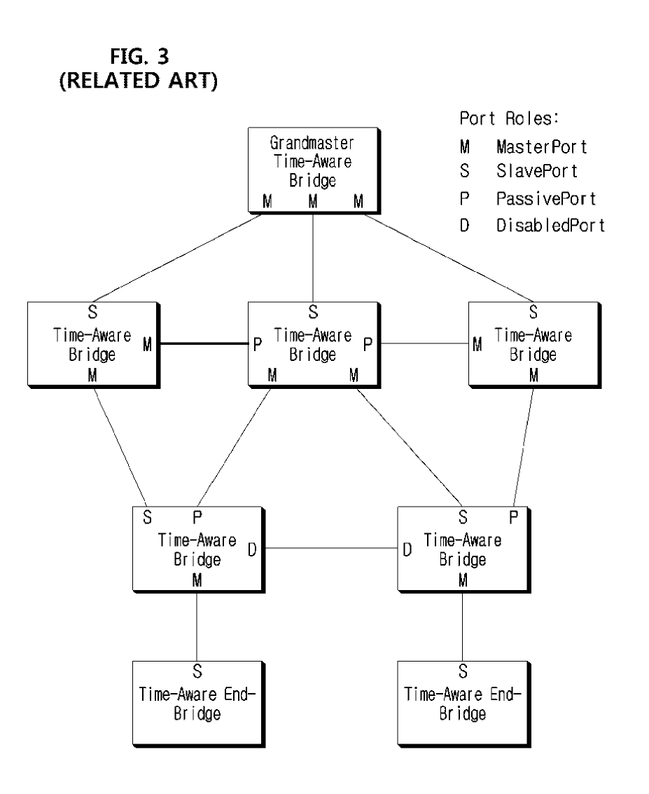

FIG. 4 is a view showing a PTP message format for FD IEEE 802.3 link as an IEEE802.1AS structure used in a terminal;

FIG. 5 is a view showing a configuration of a network system to which the present invention is applicable;

FIG. 6 is a view showing an example of a gPTP packet that a Segment Slave (SS) transmits to a Segment Master (SM); and

FIG. 7 is a view showing an example of a gPTP packet that an SM transmits to a Grand Master (GM).

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

Time synchronization between terminals connected to a network may be performed in various ways according to an application program serviced in a terminal system. A certain application program may have a function of synchronizing to another program in a software level without assistance from a network infrastructure, and a certain application program providing a different service may synchronize to another program and synchronize time to another program through a network layer 2 or layer 3 function with assistance from the network infrastructure. Representative protocols used in the application service programs are IEEE1588v1, IEEE1588v2, and IEEE802.1AS.

Exemplary embodiments of the present invention provide a method for synchronizing time in an environment where tens to hundreds of terminals having similar functions and abilities, such as super multi-view terminals, are connected to one another via a network.

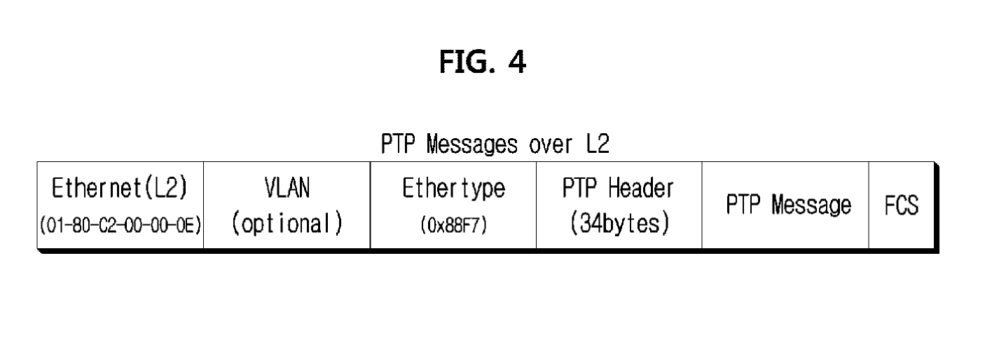

As an IEEE802.1AS structure used in terminals, a PTP message format for the FD IEEE 802.3 link is illustrated in FIG. 4. The PTP message is transmitted as a complete Ethernet packet. A destination address is fixed as “01 80 C2 00 00 0E,” and Ethertype is also fixed as “0x88F7.”

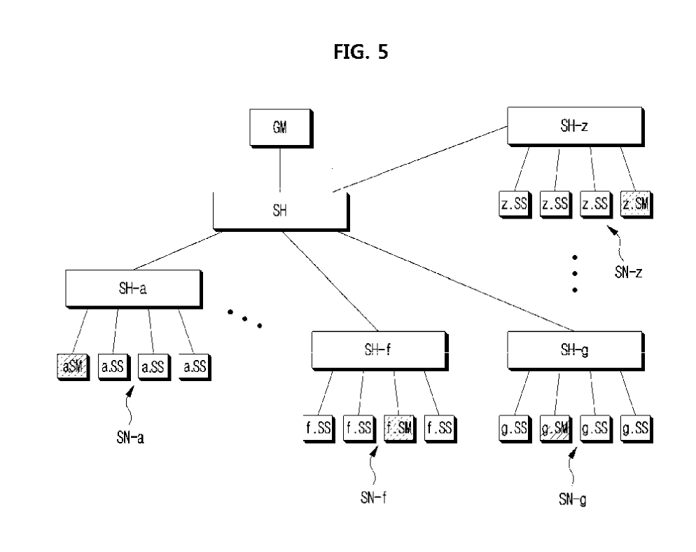

FIG. 5 is a view showing a configuration of a network system to which the present invention is applicable. As shown in FIG. 5, the network system to which the present invention is applicable includes a plurality of network segments NS-a, . . . , NS-f, NS-g, . . . , NS-z.

That is, in a network establishment/configuration initial step, the network segments NS-a, . . . , NS-f, NS-g, . . . , NS-z are formed by grouping terminals to constitute the network system.

The terminals in each of the network segments NS-a, . . . , NS-f, NS-g, . . . , NS-z are connected with one another via a single switching hub SH-a, . . . , SH-f, SH-g, . . . , SH-z. That is, the terminals belonging to the same network segment are connected with one another through a single switching hub.

The switching hub SH-a, . . . , SH-f, SH-g, . . . , SH-z may be implemented by using a low-specification switch which does not provide a gPTP function for each port.

In FIG. 5, a single switching hub (SH) is used in a single network segment (NS). However, this is merely an example. There is no limit to the structure of the network segment (NS). That is, the network segments are not physically distinguished and are logically distinguished.

In addition, as shown in FIG. 5, there exists a single Grand Master (GM) in the network system to which the present invention is applicable. The GM is an independent terminal/device which does not constitute the network segments NS-a, . . . , NS-f, NS-g, . . . , NS-z, that is, does not belong to any network segment.

One of the terminals constituting the network segments NS-a, . . . , NS-f, NS-g, . . . , NS-z is selected as a Segment Master (SM). It is preferable to select the terminal having the best performance as the SM.

The SM may be selected during the establishment/configuration process of the network system, and may be implemented to be updated when the network configuration is changed or when a breakdown occurs, or periodically.

In FIG. 5, the SMs from among the terminals constituting the network segments NS-a, . . . , NS-f, NS-g, . . . , NS-z are marked in red. A single terminal serves as the SM in every network segment.

The other terminals except for the SM are set as Segment Slaves (SSs). The SSs synchronize time to the SM of the network segment that they belong to, rather than to the switching hub. That is, a) the a.SSs which belong to the network segment NS-a synchronize time to the a.SM belonging to the same network segment NS-a, . . . , f) the f.SSs which belong to the network segment NS-f synchronize time to the f.SM belonging to the same network segment NS-f, g) the g.SSs which belong to the network segment NS-g synchronize time to the g.SM belonging to the same network segment NS-g, . . . , z) the z.SSs which belong to the network segment NS-z synchronize time to the z.SM belonging to the same network segment NS-z.

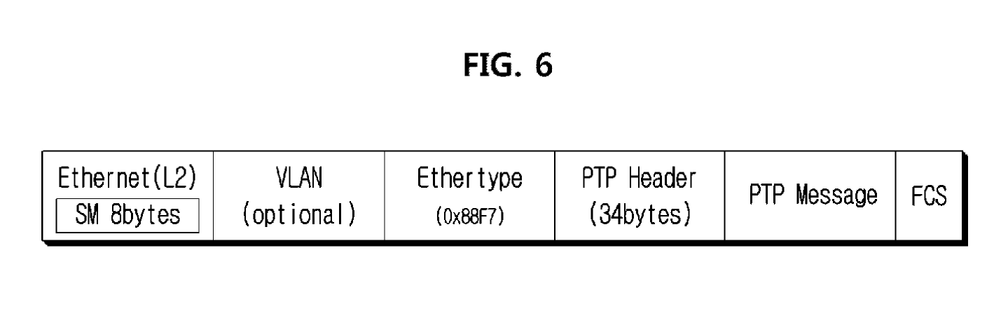

To synchronize time, the SS sets its own clock by exchanging the gPTP packet with the SM. The gPTP packet that the SS transmits to the SM is illustrated in FIG. 6 by way of an example. As shown in FIG. 6, the gPTP that the SS transmits to the SM records a uni-cast address of the SM.

The SMs synchronize time to the GM. As shown in FIG. 5, a single GM exists in the network system. Therefore, the a. SM of the network segment NS-a, . . . , the f.SM belonging to the network segment NF-f, the g.SM belonging to the network segment NS-a, . . . , the z.SM belonging to the network segment NS-z synchronize time to the GM.

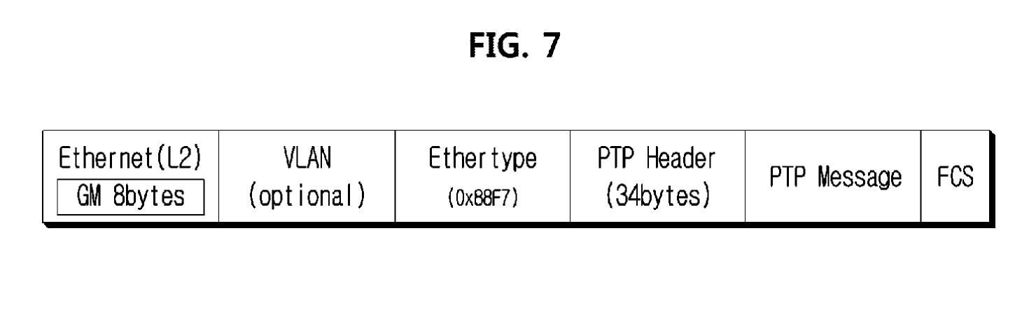

To synchronize time, the SM sets its own clock by exchanging the gPTP with the GM. The gPTP packet that the SM transmits to the GM is illustrated in FIG. 7 by way of an example. As shown in FIG. 7, the gPTP that the SM transmits to the GM records a uni-cast address of the GM.

The method for setting exact time and synchronizing time between terminals to provide services by applying a new method to the IEEE802.AS has been described up to now. This method can be embodied in a terminal system and can set and synchronize clock between system terminals even in a switch, a bridge, or a switching hub which does not have the existing IEEE802.1AS function.

The above-described network system can be used not only in a service program which provides a screen by setting and synchronizing exact time between a plurality of display terminals (tens to hundreds of terminals), but also in other network systems where a plurality of terminals are connected to provide other services.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A network segment synchronization method comprising:
forming a plurality of network segments;
selecting a single terminal in the network segment as a segment master;
setting the other terminals in the network segment as segment slaves; and
synchronizing, by the segment slaves, time to the segment master of the network segment to which the segment slaves belong.

2. The network segment synchronization method of claim 1, further comprising synchronizing, by the segment masters, time to a grand master.

3. The network segment synchronization method of claim 2, wherein the synchronizing the time to the segment master comprises synchronizing time by exchanging a gPTP packet using a uni-cast address of the segment master, and wherein the synchronizing the time to the grand master comprises synchronizing time by exchanging a gPTP packet using a unit-cast address of the grand master.

4. The network segment synchronization method of claim 2, wherein the grand master does not belong to the network segments.

5. The network segment synchronization method of claim 1, wherein the terminals constituting a single network segment are connected to a single switching hub.

6. A network system comprising:
a plurality of network segments; and
a grand master, and
wherein a single terminal is selected as a segment master in a single network segment, and the other terminals are set as segment slaves,
wherein the segment slaves synchronize time to the segment master of the network segment to which the segment slaves belong, and
wherein the segment master synchronizes time to the grand master.
